(19) United States
(12) Patent Application Publication
(10) Pub. No.: US 2008/0299276 A1
(43) Pub. Date: Dec. 4, 2008

(54) Split-Stream Processing Methods and Systems for Multi-Phase Food Products

(76) Inventors: Clint Eubanks, Houston, TX (US); John Mathew, Plano, TX (US); Sevugan Palaniappan, Plano, TX (US); Chen Chun Shao, Plano, TX (US)

Correspondence Address: CARSTENS & CAHOON, LLP, P O BOX 802334, DALLAS, TX, 75380, US

(21) Appl. No.: 11/756,370

(22) Filed: May 31, 2007

(51) Int. Cl. A23L 1/48; A23L 1/212

(52) U.S. Cl. 426/535; 426/392; 426/442; 426/506; 426/519; 426/534; 426/615; 99/483; 99/484

(57) ABSTRACT

Methods and systems are disclosed for producing a multi-phase food product by processing different phases of the food product in separate streams using different processing conditions for each stream. The separate streams are combined to produce the multi-phase food product.

### BACKGROUND OF THE INVENTION

1. Technical Field

The present invention relates to a method and system for producing multi-phase foods, such as salsa, using multiple processing streams.

2. Background

Multi-phase food products are food products that, when consumed, are mixtures of different foods with different properties. For example, one type of multi-phase food is a food that comprises a liquid base (such as a sauce) mixed with solid inclusions (such as pieces of vegetable). One example of this type of multi-phase food is salsa, which generally comprises a tomato paste base, with inclusions comprising pieces of vegetables, such as tomatoes, onions and peppers. Another example is chili, which generally comprises a tomato paste base, with inclusions of pieces of meat and pieces of vegetables such as tomatoes, onions and peppers.

Multi-phase foods, such as salsa and chili, are generally produced on a commercial scale in the prior art in a single stream batch process, wherein all of the ingredients are blended together at the beginning of the process and all of the ingredients go through each processing step together throughout the process. A need exists for an improved system and method for making multi-phase food products that maximizes the desirable properties and minimizes the undesirable properties of each phase of the food.

### SUMMARY OF THE INVENTION

The invention comprises a system and method for producing multi-phase food products by processing each phase in its own separate stream. Each separate stream is processed using parameters, conditions and unit operations specifically designed to maximize the preservation of the desirable features of the ingredients of that particular stream, and maximize the development of desirable characteristics resulting from thermal and other processing, while at the same time minimizing the negative impact any particular processing step has on that particular stream. Each separate stream includes components with similar properties, such as ingredients that react similarly to shear stress, thermal stress, flavor development, and/or water/oil miscibility. The separate streams are processed separately and combined shortly before or during final packaging. The final product characteristics of the multi-phase food products made according to the present invention have more of the desirable attributes and less of the undesirable attributes of each phase than a multi-phase food product made according to the prior art single stream process.

In one embodiment, the components of salsa are divided into a liquid phase and a solids phase and are processed in different streams under different process conditions. The liquid phase of salsa includes tomato paste, water and other components that are not highly sensitive to excessive thermal processing or shear stress. The solids phase of salsa comprises vegetable pieces and a minor amount of the liquid phase in order to facilitate transport of the solids through the process. The solids phase is processed using process conditions and equipment that minimize shear and excessive thermal stress on the solid components, whereas the liquid phase is processed in a way that maximizes the benefits of shear and thermal stress. The liquid phase and solids phase are combined together shortly before or during packaging. The result is a salsa with solid vegetable pieces that retain more of their desirable characteristics, such as crispness, vibrant color and fresh taste, and a liquid phase that has been sufficiently cooked to develop its flavor, texture and appearance.

In another embodiment of the salsa of the present invention, the onions used as ingredients in the solids phase are processed in a preconditioning stream, which ensures optimal onion flavor in the salsa by reducing the formation of several undesirable sulfur compounds. In one embodiment, the preconditioning stream processing steps comprise cutting, washing, drying and storing onions for between five and fourteen days at a temperature between about 31.6° F. and about 40° F. before being used as an ingredient in the salsa. In another embodiment, the preconditioning stream processing steps comprise cutting onions and submerging them in an acid solution before being used as an ingredient in the salsa in order to minimize the formation of undesirable sulfur compounds.

The above as well as additional features and advantages of the present invention will become apparent in the following written detailed description.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1 is a flow chart showing one embodiment of the process for continuously producing a multi-phase food product using the split-stream processing of the present invention.

FIG. 2 is a flow chart showing another embodiment of the process for continuously producing a multi-phase food product using the split-stream processing of the present invention.

### DETAILED DESCRIPTION

The present invention is a method of producing a multi-phase food product using split-stream processing steps instead of a single stream processing method. The single stream method of producing multi-phase food products leads to undesirable characteristics in the final product because each ingredient in the multi-phase food product reacts differently to each processing parameter. For example, the components of food products typically experience shear stress as they travel through each piece of processing equipment. Solid inclusions react differently to shear stresses than do liquid ingredients. Thermal processing is another typical step, which is important to sterilize food products and, thus, make them shelf stable. Solid inclusions and liquids can also react differently to thermal processing, with regards to, for example, taste, texture and color change.

For the split-stream process of the present invention, different processing conditions are chosen for each stream in order to preserve and enhance the desirable characteristics and minimize the undesirable characteristics of each of the food's phases. The following disclosure will focus on salsa production, but this is not intended to limit the scope of this invention in its broadest sense, for the principles disclosed herein apply equally as well to other multi-phase foods such as chili, salad dressing, dairy based dip, spaghetti sauce, and other sauces that contain solid inclusions.

Also, this invention is not limited to only two streams, as more than two streams may be beneficial. For example, in processing chili, depending on the processing conditions and desired final product characteristics, it could be beneficial to separately process the meat phase, the vegetable phase, and the liquid (sauce) phase, and combine them shortly before or during packaging. It may be beneficial to separately process the meat and vegetable phases due to the differences in flavor development and reaction to shear stress during processing.

In addition, this invention is not limited to multi-phase food products wherein the phases comprise a solids phase and a liquid phase. Multi-phase food products can also comprise, for example, food products that comprise an oil-based phase and a water-based phase, such as certain types of salad dressings. Depending on the desired final product, it may be desirable to process the ingredients that are soluble in the oil phase separately from the ingredients that are soluble in the water phase to ensure maximum efficiency in processing the ingredients.

In a preferred embodiment of the present invention, the multi-phase food product is salsa. In one embodiment, the salsa disclosed herein is divided into a liquid phase and a solids phase. The liquid phase of the salsa comprises the liquid components of the salsa, and optionally some minor solid components which are not susceptible to shear damage. In one embodiment of the particular salsa formulation disclosed herein, the liquid phase comprises tomato paste, water, vinegar, salt and capsicum. The flavor, texture and appearance of these liquid phase ingredients improve with sufficient thermal processing, or cooking. Moreover, the liquid phase ingredients are not particularly sensitive to shear stress. The solids phase of the salsa comprises pieces of vegetables, which are sensitive to thermal and shear stress. Excessive thermal processing can cause vegetables to lose their vibrant color, fresh flavor, and crisp texture. Likewise, shear stress can cause the vegetable pieces to break apart into smaller pieces and lose their hearty texture. In one embodiment, the solids phase vegetables comprise pieces of tomatoes, jalapenos and onions.

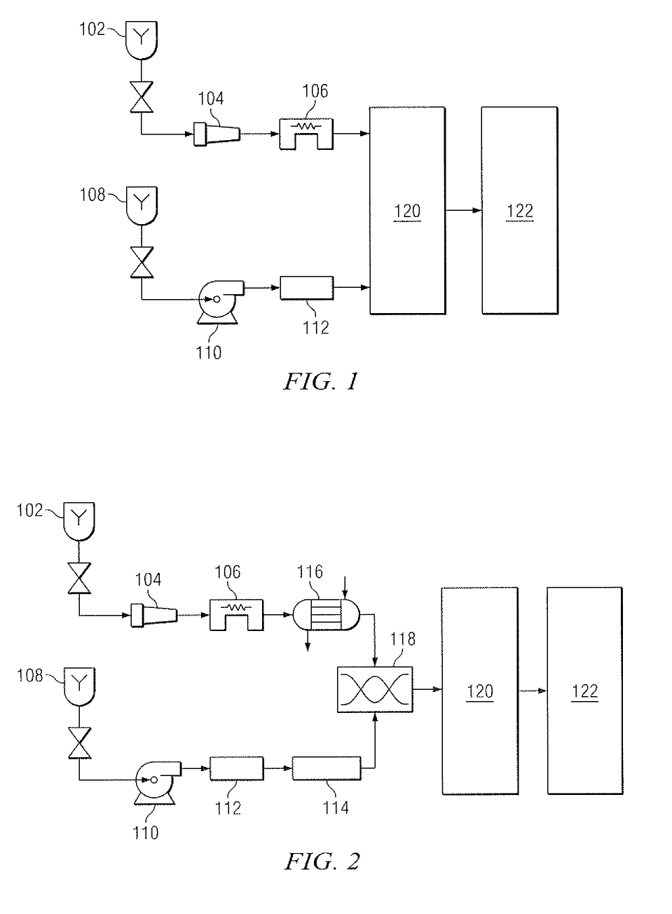

Referring to FIG. 1, according to one embodiment of the present invention, the salsa is produced using a “hot fill” process, whereby the ingredients of the salsa are heated to kill any bacteria present. The salsa containers are then filled with the salsa while it is still hot to kill any bacteria that may be present inside the salsa containers. Although the embodiment depicted in FIG. 1 depicts a “hot fill” process, the principles disclosed herein apply equally as well to an aseptic process (discussed in detail below), which sterilizes the food product and cools it before packaging. In an aseptic process, the packaging material is sterilized separately and the product is placed into the package in a sterile environment. Aseptic processing is useful for achieving commercial sterility in non-acidified foods such as milk or dairy based dips, but can also be used to make salsa.

As can be seen from FIG. 1, in the “hot fill” process the liquid stream is initially stored in a tank 108 before being pumped 110 through a shell and tube heat exchanger 112, or another indirect heat exchanger. The pump 112 used for the liquid stream are those generally known in the art as rotary pumps. Rotary pumps include, for example, positive displacement lobe pumps, centrifugal pumps, and gear pumps. Rotary pumps are efficient but impart significant shear stress on solids that pass through them. In other words, a high shear pump such as a rotary pump would damage the vegetable pieces in the solids phase of the salsa. Generally, high shear pumps are pumps that operate at a shear rate of greater than 400 reciprocal seconds.

In the shell and tube heat exchanger 112, a heating fluid, such as condensing steam or pressurized hot water, passes through the shell, while the liquid phase passes through the tube, thereby heating the liquid phase. In a shell and tube heat exchanger 112, the tube typically bends back and forth several times inside the shell, providing a large tubular surface area inside the shell through which heat transfers into the liquid phase. This arrangement is a well understood method of thermally processing liquid streams. Cooking the liquid stream in this manner develops its flavor and raises its temperature enough to kill the bacteria present. The bends in the tube also cause the contents of the liquid stream inside the tube to experience large amounts of shear stress, which would be detrimental to the vegetable pieces in the solids phase if they were included with the liquid phase in this processing step. Because there is less concern for the shear stress on the liquid phase, higher volumetric flow rates are possible for the liquid phase using the split-stream processing of the present invention than would be possible using single stream processing of the prior art.

Referring again to FIG. 1, in one embodiment the solids stream is initially stored in a tank 102 before being pumped and heated using pieces of equipment that limit the thermal and shear stress on the solid vegetable pieces in the solids phase. To reduce the amount of shear stress on the solid vegetable pieces during pumping, preferably a non-rotary pump 104 is used. For example, a progressive cavity pump, a piston pump, or a diaphragm pump can be used, each of which pumps the solids phase without significant shear stress on the vegetable pieces. Other low shear pumps can be used to practice the present invention, such as a low shear single lobe pump. Generally, a low shear pump is a pump that operates at a shear rate of less than 400 reciprocal seconds. Shear stress is also reduced by limiting the number of bends in and increasing the diameter of the pipes that transport the solids stream through the unit operations.

The shear stress on the solids phase can also be reduced by using direct heating methods to heat the solids phase. Direct heating, as that term is used herein, is heating that does not involve transferring heat from a heat source to the solids phase through an intervening medium. Examples of direct heating include, for example, microwave heating, direct steam injection, ohmic heating or a combination thereof. Each of these heaters or heating methods can be used to efficiently and precisely control the amount of thermal stress put on the solids phase, and minimize the shear stress.

In one embodiment, the solids phase of the salsa is heated using a direct steam injector 106. A direct steam injector 106 introduces steam into a product stream, which comes into direct contact with the product, condenses on it and rapidly heats it. Thus, direct steam injection has a high thermal transfer efficiency because there is no intervening medium resisting heat transfer, which means less length is needed to bring the product up to process temperature. Because less length is needed, direct steam injection offers lower pressure drop and shear force than a shell and tube heat exchanger. Direct steam injection also allows a practitioner of the present invention to precisely control the amount of thermal processing experienced by the solids stream, thereby minimizing the degradation to the flavor, texture and appearance of the vegetable pieces due to excessive thermal stress. When using a direct steam injector 106, initial product stream formulations must be chosen that take into account the amount of water added to the product stream by the direct steam injector. After thermal processing, the liquid stream and solids stream are combined in a surge tank 120, and sent to be packaged 122.

Referring to FIG. 2, for another embodiment of the present invention therein is depicted an aseptic process for split stream processing. The aseptic process is similar to the hot fill process, but instead of filling the salsa packages with hot salsa, the aseptic process fills the salsa packages with room temperature salsa. Better product attributes can result from using the aseptic process because the salsa ingredients are cooled more quickly in the aseptic process than in the hot fill process. As can be seen in FIG. 2, the liquid and solid streams are both heated in a manner similar to the hot fill process, which is depicted in FIG. 1. Specifically, the solids stream is pumped using a low shear pump 104 through a direct heater 106, such as a direct steam injector, and the liquid stream is pumped 110 through a high shear indirect heater 112, such as a shell and tube heat exchanger. After these heating steps, which kill bacteria and other organisms present in the salsa, the aseptic process cools the salsa back down to around room temperature prior to packaging. Here again, the goal of the present invention is to reduce the shear stress encountered by the solids stream. Consequently, the solids stream is first partially cooled using a single-pass multi-tube heat exchanger 116, which is capable of cooling the solids stream to a temperature between about 120° F. and about 170° F., or preferably to a temperature between about 140° F. and about 160° F. More cooling of the solids stream using an indirect heat exchanger would require increasingly more passes through the heat exchanger as the temperature of the solids stream approaches room temperature, dramatically increasing the amount of shear stress encountered by the solids. Thus, to bring the temperature of the solids stream down to room temperature efficiently and without excess shear force, the liquid stream is cooled 114, preferably using a shell and tube or scraped surface heat exchanger, to a temperature between about 32° F. and about 70° F., and then mixed with the solids stream, preferably using an inline blender 118. The cooled liquid stream comes into direct contact with the partially cooled solids stream, which quickly and efficiently cools the solid streams to room temperature. The blended salsa exits the inline blender 118 at approximately room temperature, between about 70° F. and about 90° F. In one embodiment, the blended salsa then travels to a surge tank 120 before being packaged 122.

In another embodiment, the onions used in the salsa are prepared in a separate preconditioning stream before being added to the solids stream for further processing. In the prior art, freshly cut onions or commercially dehydrated onions are used as ingredients in salsa without undergoing the preconditioning of the present invention. It has been experimentally determined that onions have optimal flavor in salsa when they have been preconditioned to reduce the formation of several pungent sulfur compounds in the onions and in the finished salsa. Specifically, the preconditioning step inhibits the formation of at least one of the following sulfur compounds in the onion: dipropyl trisulfide; dimethyl disulfide; dimethyl trisulfide; methyl-2-propenyl disulfide; and 1,3-dithiane. Most preferably, the concentrations of all of these sulfur compounds in the salsa are limited. The preferable upper concentration limit of these compounds in high quality salsa based on experimental research is summarized in the following table:

TABLE 1

| | Upper Concentration |
|---|---|
| Sulfur Compound | Limit in Salsa (ppb) |
| dipropyl trisulfide | 3.0 |
| dimethyl disulfide | 6.0 |
| dimethyl trisulfide | 1.0 |
| methyl-2-propenyl disulfide | 4.0 |
| 1,3-dithiane | 6.0 |

In one embodiment, peeled onions are introduced into the preconditioning stream and chopped into appropriately sized pieces for use in salsa. The freshly cut pieces are then washed with water. All of the excess water on the washed onions is then immediately removed by spin-drying the onions. The spin-drying step for the preconditioning stream is only meant to remove water from the surface of the onion; it is not meant to dehydrate the onion itself. Thus, the term “spin-dried onions” as used herein means chopped onions that have been washed and spin-dried to remove the excess water on their surface. In one embodiment, the spin-dried onions are used immediately as an ingredient in the salsa. In another embodiment, the spin-dried onions are stored at a temperature between about 31.6° F. and about 40° F. for a maximum length of time between 5 days and 14 days, depending on the storage temperature, before being used as an ingredient in the salsa. Spin-dried onions that are stored at about 31.6° F. can be stored for no more than 14 days, whereas spin-dried onions stored at about 40° F. can be stored for no more than 5 days. These preferred storage times and temperatures have been experimentally determined to reduce the formation of the undesirable pungent sulfur compounds in the onions such that their levels in the finished salsa are below the preferred ranges in Table 1 above.

In another embodiment, instead of being washed with water and spin-dried, the freshly cut onions in the preconditioning stream are immediately submerged in an acid solution. Preferably an acid solution with a pH less than 4.6 is used. Although any food-grade acid will work with this embodiment, in the case of salsa, preferably the acid solution is a water/vinegar mixture. Vinegar is preferable in two respects: (1) the acetic acid and other acids in vinegar inhibit the formation of the sulfur compounds discussed previously, and (2) because vinegar is typically an ingredient in salsa, less (or no) vinegar can be included in the ingredients that are added to the salsa during later processing steps. The submersion of the freshly cut onions into an acidic solution limits the formation of sulfur compounds below the concentration levels contained in Table 1 above.

Processing the onions using a pre-conditioning stream is optional, but has been found to reduce the formation of pungent, undesirable sulfur compounds within the onion during storage and processing. Furthermore, the pre-conditioning stream for onions can be used to produce salsa with optimal onion flavor using either the hot fill process or the aseptic process described above.

Optionally, the levels of the sulfur compounds in Table 1 are measured in the salsa during processing to ensure the preconditioning stream is functioning properly. The level of sulfur compounds in the salsa can be measured using solid phase microextraction gas chromatography mass spectrometry (SPME-GC-MS). For SPME-GC-MS analysis, a small sample of salsa is gathered and homogenized. About 0.5 grams of the homogenized salsa is transferred to a 20 milliliter headspace vial, to which 10 milliliters of saturated sodium chloride solution is added. An SPME fiber is inserted into the headspace of the vial, and the vial is heated at about 60° C. for about 30 minutes. Preferably the SPME fiber is polydimethylsiloxane-divinyl benzene (PDMS-DVB), an adsorbent fiber. The volatile compounds on the SPME fiber are analyzed on a GC-MS machine equipped with a DB-5 column for compound identification and quantification. The column is preferably programmed to operate at temperatures between about 50° C. and about 240° C. at a rate of about 5° C. per minute. The GC-MS data is then compared to a mass spectral library or to known standards of sulfur compounds to verify compound identity and quantity. Alternatively, any method known in the art can be used to measure the level of sulfur compounds in the salsa.

The principles of the present invention can be further illustrated, without limiting its scope, by the following example.

### EXAMPLE

### Salsa Produced Using Hot Fill Process

A high quality salsa was made according to the teachings of the present invention. The raw ingredients used in the salsa were tomato paste, water, vinegar, salt, capsicum, and pieces of jalapenos, onions and tomatoes. The raw ingredients were divided into two streams based on shear and thermal sensitivity: a liquid stream and a solids stream. Vinegar was used to balance the pH of both streams, and keep the pH of both streams below 4.6. Preferably, the pH of both streams is balanced within a range between about 3.9 and about 4.1.

The liquid stream contained tomato paste, water, vinegar, salt and capsicum, was completely liquid in nature, and was stored in a storage tank. It was pumped at a mass flow rate of 15 pounds per minute using a positive displacement lobe pump manufactured by Waukesha Cherry-Burrell, headquartered in Delavan, Wis. The liquid stream was thermally processed in a shell and tube heat exchanger using pressurized hot water as the heating fluid. The liquid stream entered the heat exchanger at a temperature of about 70° F. to 80° F. and exited the heat exchanger at a temperature between about 195° F. and about 205° F. The liquid stream comprised about 25% to about 50% of the total finished product by weight.

The solids stream contained pieces of jalapenos, onions and tomatoes, as well as tomato paste, vinegar and water. Some of the liquid ingredients in the salsa are included in the solids stream to facilitate the flow of the solids through the various processing steps. The solids stream was pumped at a mass flow rate of 30 pounds per minute using a progressive cavity pump manufactured by Seepex, headquartered in Bottrop, Germany. The progressive cavity pump is a low shear pump. The solids stream was heated using a direct steam injector. Experimental results indicate that every 10° F. increase in temperature of the solids stream requires the addition of the amount of steam equal to about 1% by weight of the total finished product. The solids stream entered the direct steam injector at a temperature of about 70° F. to about 90° F., and exited the direct steam injector at a temperature between about 200° F. and about 235° F. The solids stream comprised between about 50% and about 75% of the total finished product by weight.

Theoretical calculations indicate that the total shear force applied to the solids stream in the split-stream process of the present invention was less than ⅓ of the total shear force applied by the prior art single stream process. The vegetable pieces in the solids stream also retained more of their color, flavor and texture than vegetable pieces in salsa processed using single stream technology.

The liquid stream and solids stream were processed separately, as detailed above, and mixed together in a surge tank before being packaged into salsa containers. The final product scored favorably in consumer tests against salsa manufactured using a single stream process.

While the invention has been particularly shown and described with reference to a preferred embodiment, it will be understood by those skilled in the art that various changes in form and detail may be made therein without departing from the spirit and scope of the invention.

What is claimed is:

1. A method for making a multi-phase food product, said method comprising:
providing a first phase of said multi-phase food product;
providing a second phase of said multi-phase food product;
processing said first phase using a first set of process conditions;
processing said second phase using a second set of process conditions that are different from said first set of process conditions; and
combining said first phase with said second phase after said processing of said first phase and said processing of said second phase to produce said multi-phase food product.

2. The method of claim 1 further comprising packaging said multi-phase food product after said combining.

3. The method of claim 1 wherein said first phase and said second phase react differently to a process condition.

4. The method of claim 3 wherein said process condition comprises thermal processing.

5. The method of claim 3 wherein said process condition comprises shear force.

6. The method of claim 3 wherein said process condition comprises flavor development.

7. The method of claim 3 wherein said process condition comprises oil solubility.

8. The method of claim 3 wherein said process condition comprises water solubility.

9. The method of claim 3 wherein said multi-phase food product comprises salsa.

10. The method of claim 9 wherein said first phase comprises a solids phase and said second phase comprises a liquid phase.

11. The method of claim 10 wherein said solids phase comprises vegetable pieces and said liquid phase comprises tomato paste and water.

12. The method of claim 10 wherein said first set of processing conditions comprises a non-rotary pump and a direct heater.

13. The method of claim 1 further comprising:
providing a third phase of said multi-phase food product;
processing said third phase using a third set of process conditions which is different from said first set of process conditions and said second set of process conditions; and
combining said third phase with said first phase and said second phase after said processing of said first phase, said processing of said second phase and said processing of said third phase to produce said multi-phase food product.

14. The method of claim 13 wherein said multi-phase food product comprises chili, and wherein said first phase comprises a liquid phase, said second phase comprises a vegetable solids phase, and said third phase comprises a meat solids phase.

15. The method of claim 1 wherein said first phase comprises:
onions; and
less than about 3 parts per billion dipropyl trisulfide.

16. The method of claim 15 wherein said first phase further comprises:
less than about 6 parts per billion dimethyl disulfide.

17. The method of claim 15 wherein said first phase further comprises:
less than about 1 part per billion dimethyl trisulfide.

18. The method of claim 15 wherein said first phase further comprises:
less than about 4 parts per billion methyl-2-propenyl disulfide.

19. The method of claim 15 wherein said first phase further comprises:
less than about 6 parts per billion 1,3-dithiane.

20. A method of making salsa, said method comprising:
providing a first stream comprising tomato paste and water;
providing a second stream comprising vegetable solids;
processing said first stream using a first set of processing conditions;
processing said second stream using a second set of processing conditions which is different from said first set of processing conditions; and
combining said first stream and said second stream to produce salsa.

21. The method of claim 20 wherein said second set of process conditions comprises:
pumping said second stream using a non-rotary pump; and
heating said second stream using a direct heater.

22. The method of claim 20 wherein said first set of process conditions comprises:
heating said first stream to a temperature of at least about 185° F. using an indirect heater; and wherein said second set of process conditions comprises:
heating said second stream to a temperature of at least about 185° F. using a direct heater.

23. The method of claim 22 wherein said first set of process conditions further comprises:
cooling said first stream to a temperature between about 32° F. and about 60° F.; and
wherein said second set of process conditions further comprises:
cooling said second stream to a temperature between about 120° F. and 170° F.

24. The method of claim 21 wherein said direct heater comprises at least one of a direct steam injector, an ohmic heater, and a microwave heater.

25. The method of claim 22 wherein said direct heater comprises at least one of a direct steam injector, an ohmic heater, and a microwave heater.

26. The method of claim 21 wherein said non-rotary pump comprises at least one of a progressive cavity pump, piston pump, and diaphragm pump.

27. The method of claim 20 further comprising packaging said salsa.

28. The method of claim 20 wherein said first stream further comprises capsicum and salt.

29. The method of claim 20 wherein said vegetable solids comprise pieces of onion, tomato, and jalapeno.

30. The method of claim 20 wherein said second stream further comprises tomato paste and water.

31. The method of claim 20 further comprising:
providing a preconditioning stream comprising onions;
chopping said onions to produce chopped onions;
washing said chopped onions to produce washed onions;
spin-drying said washed onions to produce spin-dried onions; and
combining said spin-dried onions with said second stream.

32. The method of claim 31 further comprising:
storing said spin-dried onions at a temperature between about 31.6° F. and about 40° F. for no more than 5 days.

33. The method of claim 31 further comprising:
storing said spin-dried onions at a temperature of about 32° F. for no more than 14 days.

34. The method of claim 20 further comprising:
providing a pre-conditioning stream comprising onions;
chopping said onions to produce chopped onions;
submerging said chopped onions in an acid solution to produce pre-conditioned onions; and
combining said pre-conditioned onions with said second stream.

35. The method of claim 34 wherein said acid solution comprises a food-grade acid.

36. The method of claim 34 wherein said acid solution comprises vinegar.

37. The method of claim 20 further comprising:
controlling concentration in said salsa of at least one of dipropyl trisulfide, dimethyl disulfide, dimethyl trisulfide, methyl-2-propenyl disulfide, and 1,3-dithiane.

38. The method of claim 37 wherein said controlling further comprises maintaining said dipropyl trisulfide at a concentration below about 3 parts per billion in said salsa.

39. The method of claim 37 wherein said controlling further comprises maintaining said dimethyl disulfide at a concentration below about 6 parts per billion in said salsa.

40. The method of claim 37 wherein said controlling further comprises maintaining said dimethyl trisulfide at a concentration below about 1 part per billion in said salsa.

41. The method of claim 37 wherein said controlling further comprises maintaining said methyl-2-propenyl disulfide at a concentration below about 4 parts per billion in said salsa.

42. The method of claim 37 wherein said controlling further comprises maintaining said 1,3-dithiane at a concentration below about 6 parts per billion in said salsa.

43. A system for making a multi-phase food product, said system comprising:
a first phase of said multi-phase food product;
a second phase of said multi-phase food product;
a first set of process conditions;
a second set of process conditions that is different from said first set of process conditions;
a first stream which processes said first phase under said first set of processing conditions;
a second stream which processes said second phase under said second set of processing conditions; and
a third stream which combines said first stream with said second stream to produce said multi-phase food product.

44. The system of claim 43 further comprising a means for packaging said multi-phase food product.

45. The system of claim 43 wherein said first phase and said second phase react differently to a process condition.

46. The system of claim 45 wherein said process condition comprises thermal processing.

47. The system of claim 45 wherein said process condition comprises shear force.

48. The system of claim 45 wherein said process condition comprises flavor development.

49. The system of claim 45 wherein said process condition comprises oil solubility.

50. The system of claim 45 wherein said process condition comprises water solubility.

51. The system of claim 43 wherein said multi-phase food product comprises salsa.

52. The system of claim 51 wherein said first phase comprises a solids phase and said second phase comprises a liquid phase.

53. The system of claim 52 wherein said solids phase comprises vegetable pieces and said liquid phase comprises tomato paste and water.

54. The system of claim 52, wherein said first set of processing conditions comprises:
pumping said first stream using a non-rotary pump; and
heating said first stream using a direct heater.

55. The system of claim 43 further comprising:
a third phase of said multi-phase food product;
a third set of process conditions which is different from said first set of process conditions and said second set of process conditions; and
a fourth stream which processes said third phase under said third set of process conditions; and
wherein said third stream combines said first stream with said second stream and said fourth stream.

56. The system of claim 55 wherein said multi-phase food product comprises chili, and wherein said first phase comprises a liquid phase, said second phase comprises a vegetable solids phase, and said third phase comprises a meat solids phase.

57. A salsa comprising:
onions;
tomato paste;
water; and
less than about 3 parts per billion dipropyl trisulfide.

58. The salsa of claim 57 further comprising less than about 6 parts per billion dimethyl disulfide.

59. The salsa of claim 57 further comprising less than about 1 part per billion dimethyl trisulfide.

60. The salsa of claim 57 further comprising less than about 4 parts per billion methyl-2-propenyl disulfide.

61. The salsa of claim 57 further comprising less than about 6 parts per billion 1,3-dithiane.
